(19) United States
(12) Patent Application Publication
(10) Pub. No.: US 2014/0129422 A1
(43) Pub. Date: May 8, 2014

(54) SYSTEMS AND METHODS FOR ISSUING MOBILE PAYMENT CARDS VIA A MOBILE COMMUNICATION NETWORK AND INTERNET-CONNECTED DEVICES

(71) Applicants: Tiger T G Zhou, Tiburon, CA (US); Andrew H B Zhou, Tiburon, CA (US); Dylan T X Zhou, San Gabriel, CA (US)

(72) Inventors: Tiger T G Zhou, Tiburon, CA (US); Andrew H B Zhou, Tiburon, CA (US); Dylan T X Zhou, San Gabriel, CA (US)

(21) Appl. No.: 14/154,446

(22) Filed: Jan. 14, 2014

Related U.S. Application Data
(63) Continuation-in-part of application No. 13/875,311, filed on May 2, 2013.
Application No. 13/875,311 is a continuation-in-part of application No. 13/620,775, filed on Sep. 15, 2012.
Application No. 13/620,775 is a continuation-in-part of application No. 13/185,491, filed on Jul. 18, 2011.
Application No. 13/185,491 is a continuation-in-part of application No. 13/661,207, filed on Oct. 26, 2012.
Application No. 13/661,207 is a continuation-in-part of application No. 13/760,214, filed on Feb. 6, 2013.
Application No. 13/760,214 is a continuation-in-part of application No. 13/973,146, filed on Aug. 22, 2013.
Application No. 13/973,146 is a continuation-in-part of application No. 13/646,706, filed on Oct. 7, 2012.

(51) Int. Cl. G06Q 40/02

(52) U.S. Cl. CPC G06Q 40/025
USPC 705/38

(57) ABSTRACT

Provided are computer implemented methods and systems for issuing mobile payment cards via a mobile communication network. A mobile payment card may be provided to a user mobile device shortly after applying for the card issuance. A user utilizes his mobile phone to submit the application and enter user authentication information, which is used for calculating his creditworthiness rating. Based on the creditworthiness rating, a user profile is created and sent to a payment card issuing entity that considers the user profile and makes a determination as to whether or not to approve the mobile payment card issuance. In case of approval, the mobile payment card is transmitted to the user mobile device. The mobile payment card may include a payment barcode displayable on a display of the user mobile device. After scanning the displayed barcode by a barcode scanner of the merchant, the mobile payment card may be charged.

### CROSS-REFERENCE TO RELATED APPLICATIONS

This application is a continuation-in-part of U.S. patent application Ser. No. 13/875,311, entitled “FACILITATING MOBILE DEVICE PAYMENTS USING MOBILE PAYMENT ACCOUNT, MOBILE BARCODE AND UNIVERSAL DIGITAL MOBILE CURRENCY,” filed on May 2, 2013, U.S. patent application Ser. No. 13/620,775, entitled “METHODS AND SYSTEMS FOR FACILITATING MOBILE DEVICE PAYMENTS USING CODES AND CASHBACK BUSINESS MODEL,” filed on Sep. 15, 2012, U.S. patent application Ser. No. 13/661,207, entitled “METHODS AND SYSTEMS FOR RECEIVING COMPENSATION FOR USING MOBILE PAYMENT SERVICES,” filed on Oct. 26, 2012, U.S. patent application Ser. No. 13/760,214, entitled “WEARABLE PERSONAL DIGITAL DEVICE FOR FACILITATING MOBILE DEVICE PAYMENTS AND PERSONAL USE,” filed on Feb. 6, 2013, U.S. patent application Ser. No. 13/973,146, entitled “WEARABLE AUGMENTED REALITY EYEGLASS COMMUNICATION DEVICE INCLUDING MOBILE PHONE AND MOBILE COMPUTING VIA VIRTUAL TOUCH SCREEN GESTURE CONTROL AND NEURON COMMAND,” filed on Aug. 22, 2013, U.S. patent application Ser. No. 13/646,706, entitled “METHODS AND SYSTEMS FOR PREVENTING CARD PAYMENT FRAUD AND RECEIVING PAYMENTS USING CODES AND MOBILE DEVICES,” filed on Oct. 7, 2012, and U.S. patent application Ser. No. 13/185,491, entitled “FACILITATING MOBILE DEVICE PAYMENTS USING PRODUCT CODE SCANNING,” filed on Jul. 18, 2011, which are incorporated herein by reference in its entirety.

### FIELD

This application relates generally to network-based payment cards and, more specifically, to computer implemented systems and methods for issuing mobile payment cards via a mobile communication network and Internet-connected devices.

### BACKGROUND

In applying for a payment card, a customer usually has to physically visit a bank, spent some time there filling out a plurality of bank forms and standing in queues. Subsequently, the bank processes a credit card application by evaluating the creditworthiness of an applicant, verifying his credit history and employment information. In addition, the processing of payment cards, for example, carving names and card numbers on a credit card and storing magnetic information on a magnetic stripe of the card, takes a certain amount of time.

Thus, obtaining a payment card after filing an application may be a long-lasting procedure. However, customers may desire to receive a payment card immediately.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided is a computer implemented method for issuing mobile payment cards via a mobile communication network. The method may include receiving a request for issuing the mobile payment card from a mobile device of a user. The request may be associated with a credit card, a debit card, a retail card, a charge card, a bank saving account, a bank checking account, an insurance account, a stored-value card, and a universal digital mobile currency. In response to the request, the user may be prompted to enter user authentication information. The user authentication information may include a user name, a user address, a guarantor name, a user social security number, a user identification number, a user photograph, and the like. Based on the user authentication information provided by the user, a creditworthiness rating of the user may be calculated. The calculation may include checking credit history and verifying employment history and/or status of the user.

The method may further comprise creating a user profile. The user profile may include the user authentication information and the creditworthiness rating of the user. The user profile may be transmitted to a server of an issuing entity for evaluation and making a decision on denial or approval of payment card issuance.

When the decision is made, the issuing entity may transmit feedback associated with the issuance of the mobile payment card to the mobile device of the user. The feedback may include the decision on denial or approval to issue the mobile payment card. When the issue of the payment is approved, the feedback may further include a payment barcode encoding data associated with the mobile payment card. The payment barcode may be displayable on a display of the mobile device of the user and may be scannable by a barcode scanner to make a payment. The payment barcode may be a linear barcode, a two-dimensional barcode, a three-dimensional barcode, or other machine readable code.

In certain embodiments, the issuing entity may include a bank, a credit card company, a credit union, a store, and so forth.

Provided also is a system for issuing mobile payment cards via a mobile communication network. The system may comprise a database in communication with a processor configured to receive a request for issuing a mobile payment card from a mobile device of a user. In response to the request, the processor may be configured to prompt the user to enter user authentication information. Based on the user authentication information received from the user, the processor may be configured to calculate a creditworthiness rating of the user and create a user profile that may include the user authentication information and the creditworthiness rating of the user. Additionally, the processor may be configured to transmit the user profile to a server of an issuing entity for evaluation and making a decision on denial or approval of payment card issuance. The issuing entity may provide to the system a feedback associated with the issuance of the mobile payment card, which feedback may be further transmitted to the user mobile device.

In further exemplary embodiments, modules, subsystems, or devices can be adapted to perform the recited steps. Other features and exemplary embodiments are described below.

### BRIEF DESCRIPTION OF DRAWINGS

Embodiments are illustrated by way of example and not limitation in the figures of the accompanying drawings, in which like references indicate similar elements and in which:

FIG. 1 is a block diagram illustrating an environment within which the systems and methods for issuing mobile payment cards via a mobile communication network may be implemented.

FIG. 2 is a block diagram showing elements of a system for issuing mobile payment cards via a mobile communication network, in accordance with certain embodiments.

FIG. 3 is a flow chart illustrating a method for issuing mobile payment cards via a mobile communication network, in accordance with certain embodiments.

FIG. 4 is a schematic representation of issuing a mobile payment card via a mobile communication network, in accordance with certain embodiments.

FIG. 5 is a schematic diagram illustrating an example of a computer system for performing any one or more of the methods discussed herein.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

Various computer implemented methods and systems for issuing mobile payment cards via a mobile communication network are described herein. The growth in use of mobile devices (e.g., cell phones/smart phones and other similar devices) that are capable of connecting to a wireless network, such as Internet, allows implementing these novel methods and systems. Most customers shopping in today's retail environments carry such mobiles devices. Accessing the Internet from a portable mobile device has numerous benefits, the largest of which is that it allows a user to surf the Web and handle his financial matters from many locations without the use of wires. While shopping, traveling, attending sports events, airports, cinemas, and so forth, users may use their mobile devices to access the system for issuing mobile payment cards and file an application, through a mobile communication network, for instantly receiving a mobile payment card on the spot. The systems for issuing mobile payment cards via a mobile communication network is advantageous due to providing an instant mobile payment card in a form of a barcode to a user mobile device, thus preventing the risk of illegal use of credit cards or leakage of various pieces of card information due to the loss thereof, which may occur in case of physical credit cards.

The systems described herein may be financial systems associated with the issuance of instant mobile payment cards and processing mobile payments using barcodes.

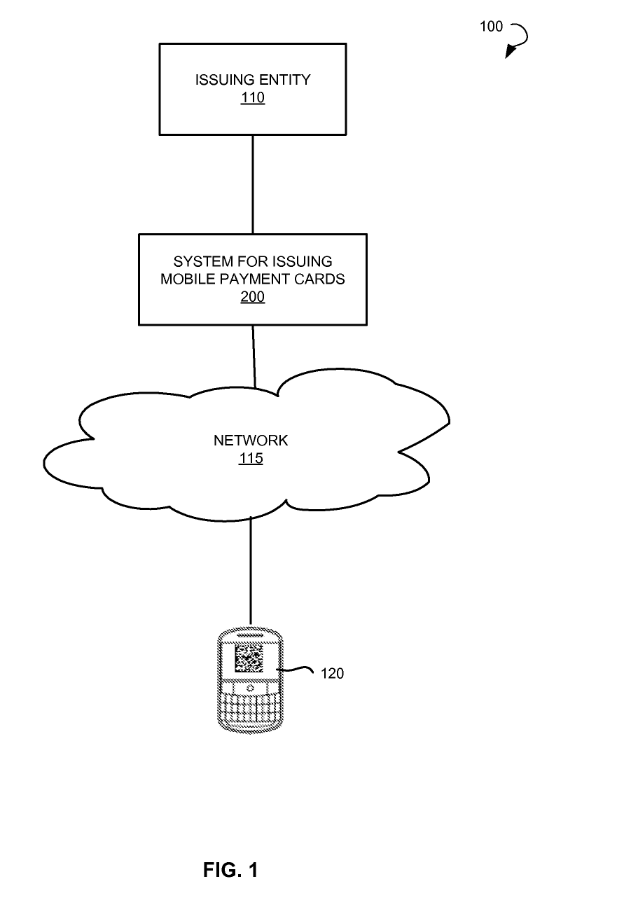

Referring now to the drawings, FIG. 1 illustrates an environment 100 within which the systems and methods for issuing mobile payment cards via a mobile communication network may be implemented. The environment 100 shows a system for issuing mobile payment cards 200, an issuing entity 110, a network 115, and a mobile device 120. The system for issuing mobile payment cards 200 may include a mobile payment card issuing server (not shown), that may be configured to issue and transmit a mobile payment card in the form of a barcode to the mobile device 120 of a user via a wireless network 115, in particular, a mobile communication network or the Internet. The server of the system for issuing mobile payment cards 200 may be also configured to communicate with the server of the issuing entity 110.

As shown, the mobile device 120 may be configured to display a barcode associated with the mobile payment card. Various examples of barcodes are described below. The barcode displayed by the mobile device 120 may be scannable by a barcode scanner (not shown), or another mobile device. The network 115 may be also used for communication among various components of the system for issuing mobile payment cards 200. The network 115 may take any suitable form of a wireless network, such as a mobile communication network or the Internet.

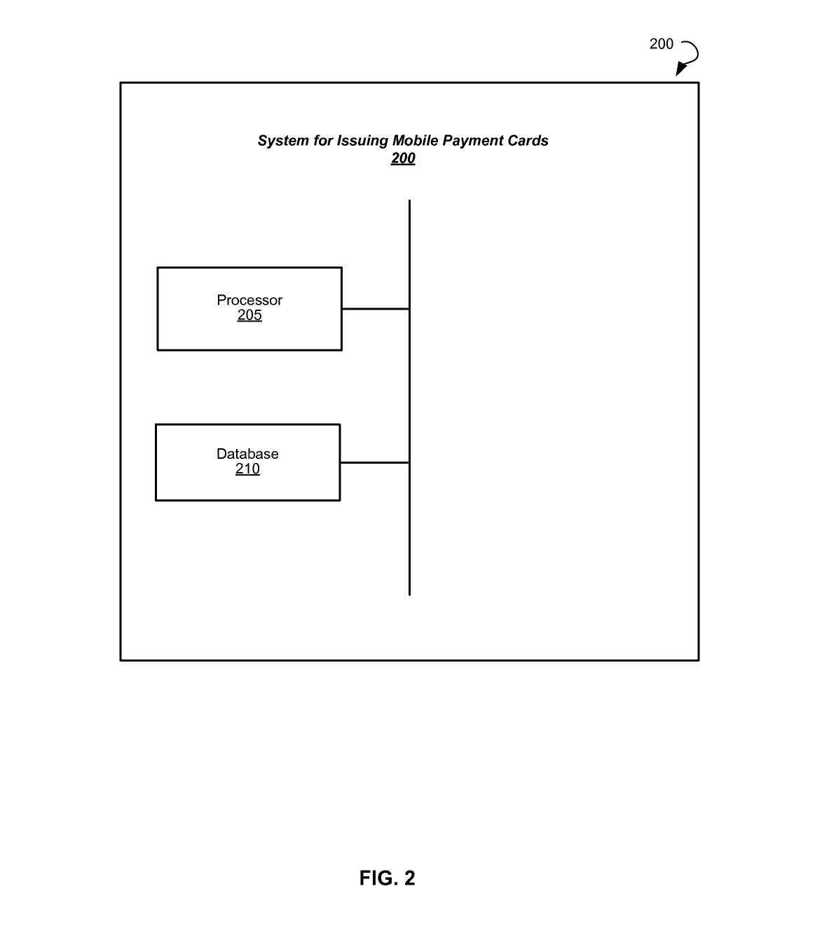

FIG. 2 is a block diagram showing modules of a system for issuing mobile payment cards 200 via a mobile communication network, in accordance with certain embodiments. Specifically, the system for issuing mobile payment cards 200 may include a processor 205 that may be configured to receive a request for issuing a mobile payment card from a mobile device of a user. The processor 205 may further be configured to prompt the user to enter user authentication information and receive the information from the user. Based on the user authentication information provided by the user, create a user profile that may include the user authentication information and the calculated creditworthiness rating of the user. The processor 205 may be further configured to transmit the user profile to a server of the issuing entity for evaluation and decision-making, receive, from the issuing entity, feedback associated with the issuance of the mobile payment card, and transmit the feedback to the mobile device of the user.

The system 200 may also include a database 210 in communication with the processor 205 for storing data associated with user profile and mobile payment card of the user.

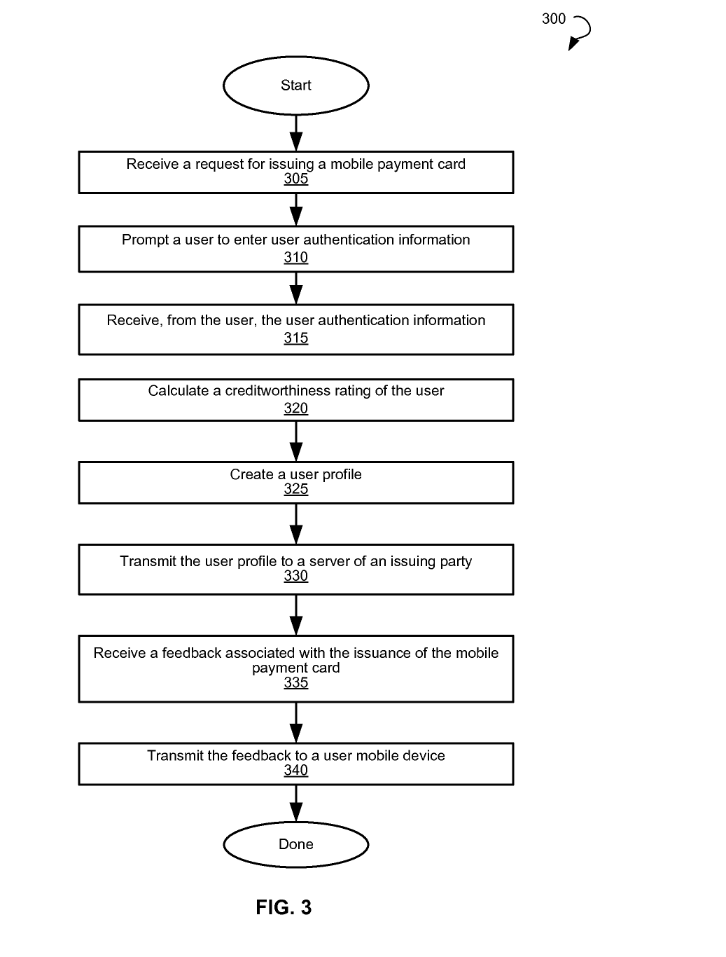

FIG. 3 is a flow chart illustrating a method 300 for issuing mobile payment cards via a mobile communication network, in accordance with certain embodiments.

Method 300 may start with receiving, from a mobile device of a user, a request for issuing the mobile payment card at operation 305. The mobile device may include a mobile phone, a laptop, a tablet personal computer, a smart phone, and so forth. The request can be transmitted via a special application for payments via mobile payment cards. In various embodiments, the application can be installed on the mobile device of the user or be a cloud-based application and accessed via a web browser.

Method 300 may proceed with prompting the user to enter user authentication information at operation 310. The user authentication information may include a name of the user, an address of the user, a guarantor name, a social security number of the user, a phone number of the user, an identification number of the user, a bank account of the user, an insurance account number of the user, a photograph of the user, and the like. The user may enter his personal data using a user interface of his mobile device. The user interface may include a touch screen display and keypad, by which the user may perform various input operations. The user authentication information may be received from the user at operation 315. Once the user authentication information is received, it may be checked for integrity. If the information passes the integrity check, it may be stored to a database of the system for issuing mobile payment cards. Otherwise, the user may be prompted to specify or add the missing information.

In certain embodiments, the user authentication information may be encrypted before transmission for security.

The user authentication information can include a password. The password may correspond to some predefined requirements, for example, the password may at least contain a minimum of 8 characters including 1 uppercase, 1 lowercase, and 1 number.

Method 300 may proceed with calculating, based on the user authentication information, a creditworthiness rating of the user at operation 320. The creditworthiness rating calculation may include checking credit history of the user and verification of employment status of the user.

Method 300 may also involve creating a user profile at operation 325 and transmitting the user profile to a server of an issuing entity at operation 330. The user profile can include a personal profile, a commercial profile, a non-profit profile, and so forth. The user profile may include a mobile payment card application, the user authentication information, and the creditworthiness rating of the user. Additionally, the user profile may be stored in the database of the system for issuing mobile payment cards.

At operation 335, feedback from the issuing entity may be received by a server of the system for issuing mobile payment cards. The feedback may include a decision to deny or approve the issuance of the mobile payment card. The feedback may be thereafter transmitted to the mobile device of the user at operation 340. If the mobile payment card application is approved, a positive feedback containing information regarding the mobile payment card may be transmitted to the system for issuing mobile payment cards, and based on the feedback, the system can issue the mobile payment card. The mobile payment card includes one or more of the following: a credit card, a debit card, a retail card, a charge card, a stored-value card, and so forth. The data of the issued mobile payment card can be transmitted to the mobile device of the user though the mobile payment card application.

In certain embodiments, the data may include a mobile payment card number. Additionally the data can include a payment barcode encoding data associated with the mobile payment card. The payment barcode may be displayable on a display of the mobile device of the user to be scanned by a barcode scanner to make a payment. The barcode scanner may include a checkout scanner, a check-in scanner, a mobile device, and so forth. The payment barcode displayed on the display of the mobile device may be a linear barcode, a two-dimensional barcode, a three-dimensional barcode, or any other machine readable code.

In some embodiments, the mobile payment card application provides additional services, such as free Voice over IP (VOIP) and Over the Top services. Thus, the mobile payment card application enables free voice communication and multimedia sessions over internet protocol networks, the free voice communication including voice communication, fax, text messages, voice-messages, and video calls. Free voice communication and multimedia sessions can be performed over public internet, Wi-Fi, 4G, 5G, 6G and upper. The user can utilize these services over the public internet, through smart phones, personal computers, and on internet access devices. Mobile payment card user may have free mobile VOIP service through AFC, cordless/DECT/PCS for short range, and wider area communication using 3G, 4G, 5G, 6G and upper protocols. Mobile payment card user may get free broadband delivery of video and audio without a multiple system operator being involved in the control or distribution of content itself over-the-top content service.

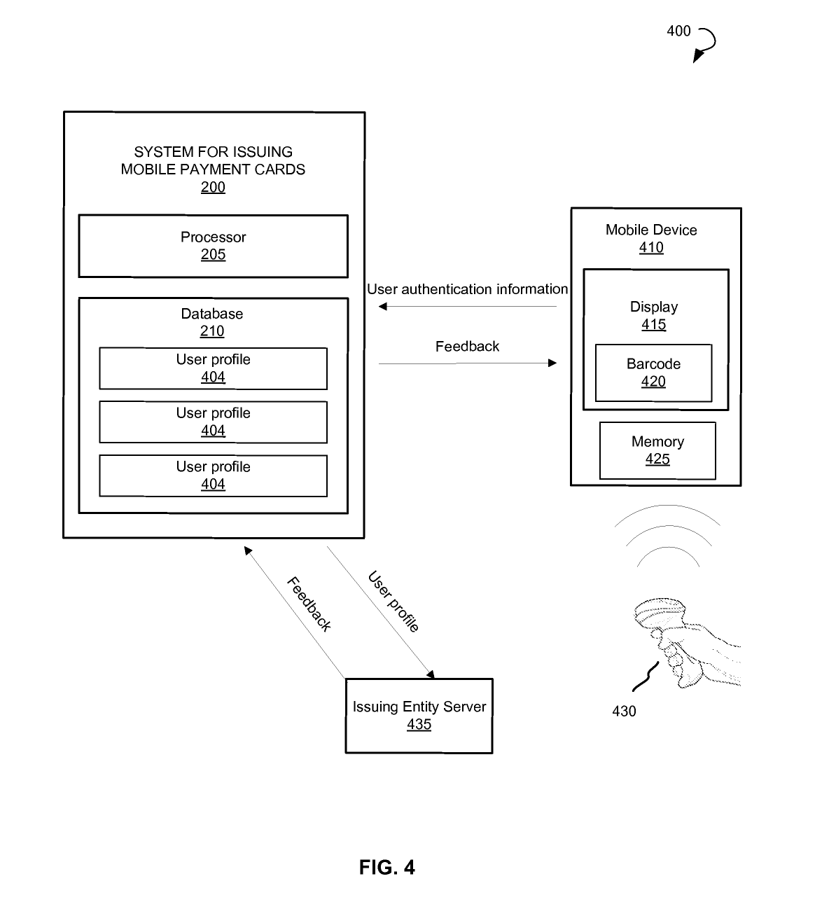

FIG. 4 is a schematic representation of issuing mobile payment cards 400 via a mobile communication network, in accordance with certain embodiments. The system for issuing mobile payment cards 200 may comprise a database 210 that stores data associated with a plurality of user profiles 404. The system 200 may also comprise a processor 205 configured to communicate with user mobile devices and issuing entities via a wireless network. The processor 205 may be configured to receive requests for issuing mobile payment cards from user mobile devices.

The system 200 may communicate with a mobile device 410 of the user. The mobile device 410 may comprise a memory 425 that stores data associated with the mobile payment card of the user. Additionally, the mobile device 410 may comprise a display 415 configurable to display barcodes.

In certain embodiments, the system 200 may use a phone number of the mobile device 410 as a main authentication key to perform various authentication operations required for managing a mobile payment card.

The issuing entity server 435 may comprise a processor (not shown) configured to receive and process the user profiles in order to determine whether the mobile payment card issuance should be denied or approved. The processor of the issuing entity may be further configured to transmit a feedback associated with the issuance of the mobile payment card back to the system for issuing mobile payment cards 200. The processor 205 of the system 200 may be configured to send the feedback received from the issuing entity server 435 and associated with the issuance of the mobile payment card to the mobile device 410 of the user.

The feedback may depend on approval of by a mobile payment provider. After the approval is granted, card holders can use it to make purchases at merchants accepting that card.

In case of approval, the feedback may comprise a mobile payment card number. The feedback may also include a payment barcode encoding data associated with the mobile payment card.

Mobile payment card may have online and offline systems. Online mobile payment cards require electronic authorization of every transaction and credits and debits are reflected in the user's account immediately. The transaction may be additionally secured with personal identification number (pin) authentication system. Offline mobile payment cards may be in barcode form on a material surface encoding all mobile payment cards information which can be decoded by scanner and any mobile device with a decoding software to make a payment.

To make a payment, the user may give a command to display a payment barcode 420 associated with the mobile payment card on the display 415 of the mobile device 410. The payment barcode 420 may be scanned by a barcode scanner 430 of a third party organization or by another mobile device. The third party organization may be an organization providing products or services for which the user wishes to pay. After scanning the payment barcode, the third party organization may send a payment request to the issuing entity. After retrieving the data of the mobile payment card from the scanned barcode 420, the issuing entity may charge the mobile payment card by transferring funds from the mobile payment card to the account of the third party organization.

In some embodiments, mobile payment card allows the user to pay for goods and services based on the promise of the user to pay for them. The issuer of mobile payment cards creates a revolving account and grants a line of credit to the user from which the user can borrow money for payment to a merchant or as a cash advance to the user. Typically, this model involves a third party entity that pays the seller and is reimbursed by the buyer.

Alternatively, the funds may be stored on the mobile payment card in a form of universal digital mobile currency. The universal digital mobile currency may be a digital currency (paper-less, contact-less, and non-physical) enabling instant payments between users, for example, a seller and a buyer, anytime and anywhere in the world. With the universal digital mobile currency, involvement of financial institution, and associated fees and charges, may be avoided. The universal digital mobile currency is issued and managed via mobile devices or mobile networks. The universal digital mobile currency may be stored on the user mobile device or an on-line wallet, transmitted and received in a peer-to-peer manner via the user mobile device, an on-line resource, and mobile device application. The universal digital mobile currency may be owned, transferred, purchased, and sold by the user virtually or in real life.

To protect users, the issuing entities may set limits on operations in the universal digital mobile currency, the limits including a limit for a pre-determined period, a number of transactions limit, and a maximum amount per transaction.

Additionally, the universal digital mobile currency associated with the mobile payment card may be encrypted, for example, using high standard encryption that is used in military and government applications. Moreover, payments in the universal digital mobile currency may be protected by a digital signature and a password. Thus, risk of fraud, chargeback, and identity theft associated with Internet payments may be eliminated.

In some embodiments, a transfer from the mobile payment card of the user to an account of the merchant or another mobile payment card may be performed in the universal digital mobile currency. Additionally, funds transfers in the universal digital mobile currency may be performed to other types of accounts, for example, to the account of the user in an on-line gaming system.

In certain embodiments, the mobile payment card may be associated with a physical credit card, a debit card, and other cards owned by the user. In addition, the mobile payment card may be used even in the case when the user has not yet received a physical card or does not wish a physical card to be issued, such that the mobile payment card may have the same validity, functions and provisions as that the physical card.

In certain embodiments, the user may obtain several mobile payment cards using a single mobile device.

Upon providing user authentication information via a user interface of a mobile device, a user may receive a mobile payment card from an issuing entity. The mobile device may include a mobile phone, a lap-top, a tablet PC, a smart phone, and so forth. The mobile payment card may be used for performing financial transactions, for example, for buying products or services. The issuing entity may include any financial organization, such as a bank, an insurance company, a credit card company, a credit union, a store, and the like, that may provide the mobile payment card to the user upon receipt of the user authentication information. The issuing entity may be associated with chain stores, for example, Starbucks, and franchise organizations, such as McDonald's, to operate a large scale banking service of these organizations without bank charges.

The user authentication information, provided to receive a mobile payment card, may include a name of the user, an address of the user, a guarantor name, a social security number of the user, a phone number of the user, an identification number of the user, a bank account of the user, an insurance account number of the user, a photograph of the user, and the like. In some embodiments, the mobile payment card may not be associated with any existing payment card of the user.

In certain embodiments, applying for the mobile payment card may be performed through the mobile device of the user, for example, by installing a card issuance application on the mobile device. The card issuance application may be configured to communicate with the issuing entity and manage the issuance process of the mobile payment card.

In certain embodiments, the mobile payment card may be associated with a mobile payment account of the user utilizing the card issuance application. The mobile payment account may be associated with a mobile payment service provider and created on a request of the user. Additionally, the mobile payment card can be associated with a bank card to be charged when a payment via the mobile payment card is made. The user can select which account to charge when processing a transaction.

The user may access the mobile payment card any time and may perform any operations, such as pay for a product, transfer funds to a banking account or another mobile payment account, make a deposit to the mobile payment account, and so forth. The mobile payment card can encode one or more of the following: a picture of a face of the user, one or more fingerprints of the user, and a pin code. In some embodiments, the user can specify a time period during which the mobile payment card is valid.

When the user is willing to buy a product or a service, instead of using a plastic payment card, cash, or check, the user may activate an application on his mobile device and instantly obtain a mobile payment card. The mobile payment card may include a barcode that encodes data of the mobile payment card.

The data associated with the mobile payment card may be stored in a memory unit of the user mobile device or a remote secure cloud server. Additionally, the data associated with the mobile payment card may be stored in a database of the issuing entity. Upon a request of the user, the data associated with the mobile payment card may be displayed on a display of the user mobile device, for example, in a form of a barcode being scannable by a barcode scanner 430. User data and mobile payment cards can be protected via an on-demand contact list backup and retrieval to and from the cloud.

The mobile payment card can be used in a way similar to bank cards, for example, it can be used for internet payments, provide cash-back according to predetermined conditions, enable SMS/USSD-based transactional payments, direct operator billing, credit card mobile payments, online wallets, QR code payments, contactless near field communication, cloud-based mobile payments, audio signal-based payment (which uses near sound data transfer or data over voice, and NFC produces audio signatures that the microphone of the mobile device can pick up to enable electronic transaction), and direct carrier/bank co-operation. Mobile payment cards service provider may have operator-centric model, bank-centric model, collaboration model and peer to peer independently model, and beacon mobile payment using Bluetooth Low Energy signal connecting applications.

Direct mobile billing option can be applied during checkout at a e-commerce site. After two-factor authentication involving a pin and one time password, the user's mobile account is charged for the purchase, thus bypassing banks and plastic payment card companies altogether. Direct operator billing or carrier billing can require integration with the mobile operator to add to customer's bill to provide instantaneous payment. Direct operator billing may be deployed in an in-app environment.

In some embodiments, the user makes payments via web pages displayed or additional applications downloaded and installed on the mobile device. For this purpose, a wireless application protocol (WAP) can be used as underlying technology and the mobile web payment can lead back to a store or to other goods the user may like.

As an easy way to inject information into a mobile device, barcodes can be used. The user just clicks to open the application, directly showing the encoded payment card on the screen. Merchant just scans the barcode information and gets paid.

Contactless near field communication (NFC) may be used in paying for purchases in physical stores or transportation services. The mobile device may be equipped with a smart card. When a user waves the device near a radar module a payment is made. In some cases, the payment may require authentication. The NFC payment could be deducted from a pre-paid account or changed to a mobile or band account directly. NFC payment may include displaying a barcode on the mobile device screen for mobile payment.

The audio channel of the mobile phone may be another wireless interface that is used to make payments. Chip, ultra sound and acoustic features of mobile phone may support mobile payments. Near sound data transfer (NDST), data over voice and NFC produce audio signatures that the mobile phone can pick up to enable electronic transactions.

In some embodiments, a beacon mobile payment sends out a Bluetooth Low Energy (BLE) signal to anyone or any device with mobile application to transfer payment data and get electrical receipt. When a customer checks in, their picture and name may pop up on the retailer's point-of-sale system, when a sales associate at the store totals a bill on a cash register or a card-reading terminal, the beacon mobile payment user gives verbal confirmation to the associate, who matches the customer with the picture on the POS screen and concludes the transaction.

In some embodiments, merchants may be charged a predefined fee for accepting mobile payment cards. The fee of, for example, 0.3 to 5 percent of the value of each transaction may be charged by mobile payment card issuer. The merchant may also pay a variable interchange rate fees for each transaction in certain cases, merchants are also required to lease processing terminals such as scanner, mobile devices. Merchants can also be required to satisfy data security compliance, and in some cases, merchants may assume the risk of charge backs by consumers. The issuer charges may be lower than plastic payment cards when mobile payment card users directly pay to merchant rather than through third party such as bank.

The mobile payment card can be used with a customized version of the open standard Extensible Messaging and Presence Protocol. Upon installation of the mobile payment card application, a user account is created using the phone number or name of the user as user name. The mobile payment cards application and user name automatically compares all the phone numbers from the device address book with its central database of users to automatically add contacts and send mobile payment cards barcode to the user's contact list to charge the payments.

Additionally, the mobile payment card application can include a cross-platform instant messaging subscription service. The cross-platform instant messaging subscription service can be a free mobile messages application for mobile devices, such as smartphones, with free text and free call features, hold-to-talk messaging, broadcast messaging, photo and video sharing, location sharing, contact information exchange, and social networking payment support. For any of the features, the user can specify a validity period. Via the service, the user can send one or more mobile payment card barcodes, images, video, and audio media messages to further users. The cross-platform instant messaging subscription service can be compatible with Google Android, iPhone IOS, Microsoft Windows Phone and other operation systems.

Furthermore, the mobile payment card application can provide tools to capture one or more images, embellish the one or more images with artistic filters and captions, and place the one or more images into a personal photo journal for sharing with further users.

The mobile payment service provider may have operator-centric model. Mobile operator may act independently to deploy mobile payment service. The operator could provide an independent mobile wallet from the user mobile account. The mobile payment service provider may act independently from financial institutions and mobile network operators to provide mobile payment by a peer-to-peer model. Via barcode, SMS, ultra sound, data over voice, near sound data transfer (NSDT) and acoustic features of mobile phone, user may pay personal debts, pay POS merchants, pay online merchants, pay international remittance, and pay digital purchases instantly.

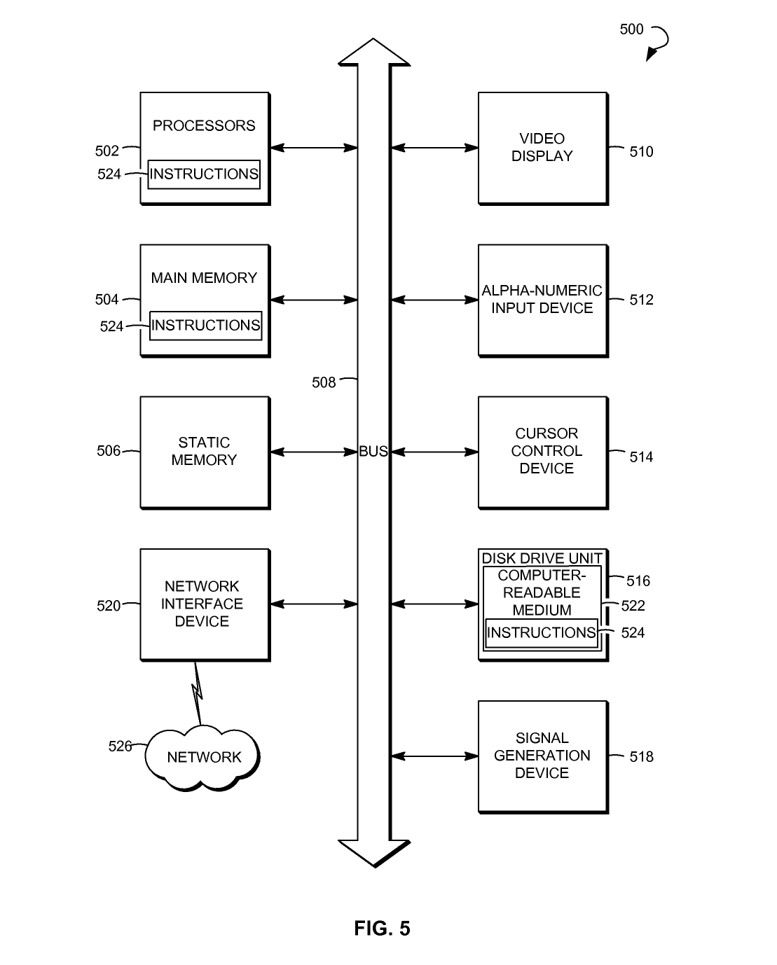

FIG. 5 shows a diagrammatic representation of a machine in the example electronic form of a computer system 500, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a cellular telephone, a portable music player, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor or multiple processors 502 (e.g., a central processing unit (CPU), a graphics processing unit (GPU), or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 may also include an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a computer-readable medium 522, on which is stored one or more sets of instructions and data structures (e.g., instructions 524) embodying or utilized by any one or more of the methodologies or functions described herein. The instructions 524 may also reside, completely or at least partially, within the main memory 504 and/or within the processors 502 during execution thereof by the computer system 500. The main memory 504 and the processors 502 may also constitute machine-readable media.

The instructions 524 may further be transmitted or received over a network 526 via the network interface device 520 utilizing any one of a number of well-known transfer protocols (e.g., Hyper Text Transfer Protocol (HTTP)).

While the computer-readable medium 522 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, flash memory cards, digital video disks, random access memory (RAMs), read only memory (ROMs), and the like.

The example embodiments described herein may be implemented in an operating environment comprising software installed on a computer, in hardware, or in a combination of software and hardware.

Thus, various systems and methods for issuing mobile payment cards via a mobile communication network have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A computer implemented method for issuing mobile payment cards via a mobile communication network, the method comprising:
receiving, from a mobile device of a user, a request for issuing a mobile payment card, wherein the request is received through an application associated with the mobile payment cards, the application being installed on a device associated with the mobile device of the user;
in response to the request, prompting the user to enter user authentication information;
receiving, from the user, the user authentication information;
based on the user authentication information, calculating a creditworthiness rating of the user;
creating a user profile, the user profile including the user authentication information and the creditworthiness rating of the user, wherein the user profile includes a personal profile, a commercial profile, and a non-profit profile;
transmitting the user profile to a server of an issuing entity;
receiving, from the issuing entity, feedback associated with the issuance of the mobile payment card;
transmitting the feedback associated with the issuance of the mobile payment card to the mobile device of the user.

2. The method of claim 1, wherein the feedback includes a decision to deny the issuance of the mobile payment card.

3. The method of claim 1, wherein the feedback includes a decision to approve the issuance of the mobile payment card.

4. The method of claim 1, further comprising: based on the feedback, issuing the mobile payment card, wherein the mobile payment card is transmitted to the mobile device of the user though the application.

5. The method of claim 4, wherein the issuing includes generating a payment barcode encoding data associated with the mobile payment card, wherein the mobile payment card is associated with the user authentication information.

6. The method of claim 5, wherein the payment barcode is displayable on a display of the mobile device of the user to be scanned by a barcode scanner to make a payment.

7. The method of claim 5, wherein the payment barcode includes one or more of the following: a linear barcode, a two-dimensional barcode, a three-dimensional barcode, and a machine readable code.

8. The method of claim 1, wherein calculating the creditworthiness rating of the user includes checking credit history of the user.

9. The method of claim 1, wherein calculating the creditworthiness rating of the user includes verification of employment status of the user.

10. The method of claim 1, wherein the mobile payment card includes one or more of the following: a credit card, a debit card, a retail card, a charge card, a bank saving account, a bank checking account, an insurance account, a stored-value card, and a universal digital mobile currency.

11. The method of claim 1, wherein the mobile device includes one or more of the following: a mobile phone, a laptop, a tablet personal computer, a smart phone, an Internet-connected device, and a wearable personal digital device.

12. The method of claim 1, wherein the issuing entity includes one or more of the following: a bank, a credit card company, an insurance company, a credit union, and a store.

13. The method of claim 1, wherein the feedback associated with the issuance of the mobile payment card is transmitted to the mobile device of the user through a wireless network.

14. The method of claim 1, wherein the user authentication information includes one or more of the following: a name of the user, an address of the user, a guarantor name, a social security number of the user, a phone number of the user, an identification number of the user, a bank account of the user, an insurance account number of the user, and a photograph of the user.

15. The method of claim 1, wherein the application enables free voice communication and multimedia sessions over internet protocol networks, the free voice communication including voice communication, fax, text messages, voice-messages, and video calls.

16. The method of claim 1, wherein free voice communication and multimedia sessions are performed over public internet, Wi-Fi, 4G, 5G, 6G and upper.

17. The method of claim 1, further comprising: receiving content over broadband communication.

18. The method of claim 1, wherein the user applies the mobile payment card using a further device.

19. The method of claim 1, wherein the mobile payment card is associated with a revolving account and a credit line granted to the user for making payments.

20. The method of claim 1, wherein the issuing depends on approving of the mobile payment account by a mobile payment provider.

21. The method of claim 2, wherein the mobile payment card is used as a prepaid card.

22. The method of claim 1, wherein the mobile payment card is associated with one or more of the following: a daily limit for a maximum amount of expenditures, a limit for a minimum balance.

23. The method of claim 1, wherein the mobile payment card is used for internet payments.

24. The method of claim 1, wherein the mobile payment card provides cash-back according to predetermined conditions.

25. The method of claim 1, wherein the mobile payment card is a virtual card, information of the mobile payment card being encoded in a barcode.

26. The method of claim 1, wherein the mobile payment card is associated with transactional payments based on Unstructured Supplementary Service Data (USSD) or Short Message Service (SMS), direct operator billing, credit card mobile payments, online wallets, QR code payments, contactless near field communication, cloud-based mobile payments, audio signal-based payment, and direct carrier/bank co-operation.

27. The method of claim 1, wherein a merchant associated with the purchase is charged with a predefined fee deducted from the payment amount.

28. The method of claim 1, wherein a mobile payment card service provider has operator-centric model, bank-centric model, collaboration model or peer-to-peer independent model.

29. A system for issuing mobile payment cards via a mobile communication network, the system comprising:
a database in communication with a processor, the processor configured to:
receive, from a mobile device of a user, a request for issuing a mobile payment card;
in response to the request, prompt the user to enter user authentication information;
receive, from the user, the user authentication information;
based on the user authentication information, calculate a creditworthiness rating of the user;
create a user profile including the user authentication information and the creditworthiness rating of the user, wherein the user profile is stored in the database;
transmit the user profile to a server of an issuing entity;
receive, from the issuing entity, feedback associated with the issuance of the mobile payment card;
transmit the feedback associated with the issuance of the mobile payment card to the mobile device of the user.

30. The system of claim 29, wherein the feedback includes a decision to deny the issuance of the mobile payment card.

31. The system of claim 29, wherein the feedback includes a decision to approve the issuance of the mobile payment card.

32. The system of claim 31, wherein the feedback further includes a payment barcode encoding data associated with the mobile payment card, wherein the mobile payment card is associated with the user authentication information.

33. The system of claim 32, wherein the payment barcode is displayed on a display of the mobile device of the user to be scanned by a barcode scanner to make a payment.

34. The system of claim 32, wherein the payment barcode includes one or more of the following: a linear barcode, a two-dimensional barcode, a three-dimensional barcode, and a machine readable code.

35. The system of claim 29, wherein calculating the creditworthiness rating of the user includes checking credit history of the user.

36. The system of claim 29, wherein calculating the creditworthiness rating of the user includes verification of employment status of the user.

37. The system of claim 29, wherein the mobile payment card includes one or more of the following: a credit card, a debit card, a retail card, a charge card, and a stored-value card.

38. The system of claim 29, wherein the mobile device includes one or more of the following: a mobile phone, a personal digital assistant, a laptop, a tablet personal computer, a smart phone, and a wearable personal digital device.

39. The system of claim 29, wherein the issuing entity includes one or more of the following: a bank, a credit card company, an insurance company, a credit union, and a store.

40. The system of claim 29, wherein the feedback associated with the issuance of the mobile payment card is transmitted to the mobile device of the user through a wireless network.

41. The system of claim 29, wherein the user authentication information includes one or more of the following: a name of the user, an address of the user, a guarantor name, a social security number of the user, a phone number of the user, an identification number of the user, a bank account of the user, an insurance account number of the user, and a photograph of the user.

42. The system of claim 29, wherein an online payment using the mobile payment card is secured by two-factor authorization.

43. The system of claim 29, wherein the user makes a payment via the mobile payment card through an application on the mobile device.

44. The system of claim 29, wherein a payment via the mobile payment card is performed as a direct operator billing.

45. The system of claim 29, wherein the mobile payment card is associated with a bank card, wherein the user specifies whether a payment is charged to the bank card.

46. The system of claim 29, wherein the processor is further configured to, on receiving an audio signal via near sound data transfer or data over voice, display a payment barcode encoding data associated with the mobile payment card on a screen of the mobile device of the user.

47. The system of claim 29, wherein the processor is further configured to, on receiving a signal by near field communication, perform a payment using the mobile payment card, wherein the payment is performed on condition of an approval of the user.

48. The system of claim 29, wherein the processor is further configured to, on receiving an audio signal via near sound data transfer or data over voice, enable an electronic transaction through the mobile payment card.

49. The system of claim 29, wherein the issuing entity is a mobile operator.

50. The system of claim 29, wherein the issuing entity acts independently from financial institutions and mobile operators.

51. The system of claim 29, wherein the issuing entity is a collaborative body including a bank, a mobile operator, and a trusted third party.

52. The system of claim 29, wherein the processor is further configured to receive a Bluetooth Low Energy (BLE) signal, the BLE signal being sensed by the mobile device of the user, the user being authenticated via the BLE signal.

53. The system of claim 29, wherein the mobile payment card is used with a customized version of the open standard Extensible Messaging and Presence Protocol, wherein a user account is created using a phone number or a name associated with the mobile device of the user, and wherein phone numbers in an address book of the mobile device are compared with a central database of users to automatically add contacts and send mobile payment cards barcode to the contacts of the user to charge the payments.

54. The system of claim 29, wherein the mobile payment card is used with a cross-platform instant messaging subscription service, wherein the user sends one or more mobile payment card barcodes, images, video, and audio media messages to further users, the cross-platform instant messaging subscription service being compatible with Google Android, iPhone IOS, Microsoft Windows Phone and other operation systems, wherein the cross-platform instant messaging subscription service is a free mobile messages application for smartphones with features of: free text and free call, hold-to-talk messaging, broadcast messaging, photo and video sharing, location sharing, contact information exchange, and social networking payment support, wherein the user specifies a validity period for any of the features.

55. The system of claim 29, wherein the processor is further configured to provide tools to capture one or more images, embellish the one or more images with artistic filters and captions, place the one or more images into a personal photo journal for sharing with further users.

56. The system of claim 29, wherein user data and mobile payment cards are protected via an on-demand contact list backup and retrieval to and from the cloud.

57. The system of claim 29, wherein the user specifies a time period during which the mobile payment card is valid.

58. The system of claim 29, wherein the mobile payment card encodes one or more of the following: a picture of a face of the user, one or more fingerprints of the user, and a pin code.

59. A non-transitory computer-readable medium comprising instructions, which when executed by one or more processors, perform the following operations:
receive, from a mobile device of a user, a request for issuance of a mobile payment card;
in response to the request, prompt the user to enter user authentication information;
receive, from the user, the user authentication information;
based on the user authentication information, calculate a creditworthiness rating of the user;
create a user profile including the user authentication information and the creditworthiness rating of the user;
transmit the user profile to a server of an issuing entity;
receive, from the issuing entity, feedback associated with the issuance of the mobile payment card;
transmit the feedback associated with the issuance of the mobile payment card to the mobile device of the user.
